(19) United States
(12) Patent Application Publication
(10) Pub. No.: US 2014/0216273 A1
(43) Pub. Date: Aug. 7, 2014

(54) APPARATUS FOR COOKING AND SMOKING FOOD

(71) Applicant: ALFINITY USA, LLC, Buda, TX (US)

(72) Inventor: Joe Burch, Round Rock, TX (US)

(73) Assignee: Alfinity USA, LLC, Buda, TX (US)

(21) Appl. No.: 13/790,293

(22) Filed: Mar. 8, 2013

Related U.S. Application Data
(60) Provisional application No. 61/761,028, filed on Feb. 5, 2013.

(51) Int. Cl. A23B 4/052; A47J 37/06

(52) U.S. Cl. CPC A23B 4/0523; A47J 37/06
USPC 99/445

(57) ABSTRACT

A food cooking apparatus is disclosed. The food cooking apparatus comprises a smoker with a smoker cabinet and an oven with an oven cabinet. The oven typically overlies the smoker. Both the smoker and oven have separate independently controlled heating elements. The walls of the cabinets of the smoker and the oven are adapted such that almost all or no gas passes from the underlying smoker to the overlying oven. This is achieved by having a solid wall between the interior of the oven separating it from the interior of the smoker.

This is a utility patent application that claims priority from U.S. Provisional Patent Application Ser. No. 61/761,028, filed Feb. 5, 2013, and is incorporated by reference herein.

### FIELD OF THE INVENTION

Food cooking assemblies, more specifically, a food cooking assembly having a vertical smoker on the bottom thereof and an oven on the top of the vertical smoker, both oven and smoker having separate heating elements and being gaseously sealed one from the other.

### BACKGROUND

Food cooking assemblies may be provided for grilling, smoking, frying or otherwise preparing food using heat sources. Those heat sources may be gas, electric or wood.

Occasionally, cooking assemblies will provide structure for achieving both smoking and cooking. However, these typically do not separate the smoking and cooking or oven functions and provide for a single, typically wood-fired heat source.

### SUMMARY OF THE INVENTION

A food cooking apparatus is disclosed. The food cooking apparatus comprises a smoker with a smoker cabinet and an oven with an oven cabinet. The oven typically overlies the smoker. Both the smoker and oven have separate independently controlled heating elements. The walls of the cabinets of the smoker and the oven are adapted such that almost all or no gas passes from the underlying smoker to the overlying oven. This is achieved by having a solid wall between the interior of the oven separating it from the interior of the smoker.

A food cooking apparatus comprising a smoker, the smoker having a smoker cabinet having sidewalls, a closed top wall and a bottom wall. The cabinet walls define a cabinet interior, and a door moveable between an open position and closed position provides access to the cabinet interior. A smoker control panel engages the smoker cabinet, the control panel having a control valve engaged therewith. A smoker heating element comprises either an electrical element or a gas element. The heating element is disposed in the cabinet interior above the bottom wall thereof and engages the control valve. A wood chip container may be provided. At least one cooking grid assembly is provided in the smoker cabinet interior. A cabinet smoker damper assembly engages the smoker cabinet so as to provide gaseous communication between the interior of the smoker cabinet and an exterior thereof. An oven includes an oven cabinet, the oven cabinet having side walls and a cabinet floor, and a top wall. The oven door is moveable between an open and a closed position, the open position allowing access to the cabinet interior, the closed position preventing such access, the oven cabinet is typically located above the smoker cabinet and is in gas sealing relation with the smoker cabinet such that gas in the interior of the smoker and gas in the interior of the oven do not communicate with one another. An oven control panel has a control valve engaged therewith. The oven includes an oven heating element, the oven heating element comprising either a gas or an electrical element, the overheating element disposed in the oven cabinet interior, the oven heating element engages the control valve of the oven control panel. A grid or a rack is disposed within the oven cabinet. An oven damper assembly engages the oven cabinet so as to provide for the communication of gases between the interior of the cabinet and the exterior thereof. An energy source energizes the heating elements of the smoker and the oven. The cabinet smoke damper assembly is engaged with the side walls of the smoker cabinet. The smoker cabinet typically has a vertical dimension greater than the horizontal dimension thereof. The oven cabinet and the smoker cabinet typically each have thermometers engaged therewith, at least a portion of which are adapted to engage the interior of each cabinet. The length and width of the side walls of the oven cabinet, in one embodiment, are substantially the same as the length and width of the smoker cabinet.

### BRIEF DESCRIPTION OF THE DRAWINGS

FIGS. 1 and 2 are perspective views of the exterior of Applicant's food cooking apparatus.

FIG. 3 is a front perspective view of the interior of the smoker.

FIG. 4 is a detail view of the grid and rail assembly, which may be used without Applicant's food cooking apparatus or with any other food cooking apparatus.

FIGS. 4A and 4B are partial perspective views of separation walls that can be used to separate the oven cabinet from the smoking cabinet so as to effectively prevent gaseous communication between the two.

FIGS. 5A and 5B are perspective detail views of the grid assemblies that may be used with Applicant's cooking apparatus or with any other cooking apparatus that utilizes a slide-out grid.

FIG. 5 is perspective view of the interior of the smoker cabinet with the grid partially slid out.

FIGS. 6 and 7 are perspective views of Applicant's cooking and smoking apparatus with both the smoker and oven doors open.

FIG. 7 is a perspective view of the interior of the oven.

FIGS. 8-10 are views of an embodiment of Applicant's grid assembly.

### DETAILED DESCRIPTION OF PREFERRED EMBODIMENTS

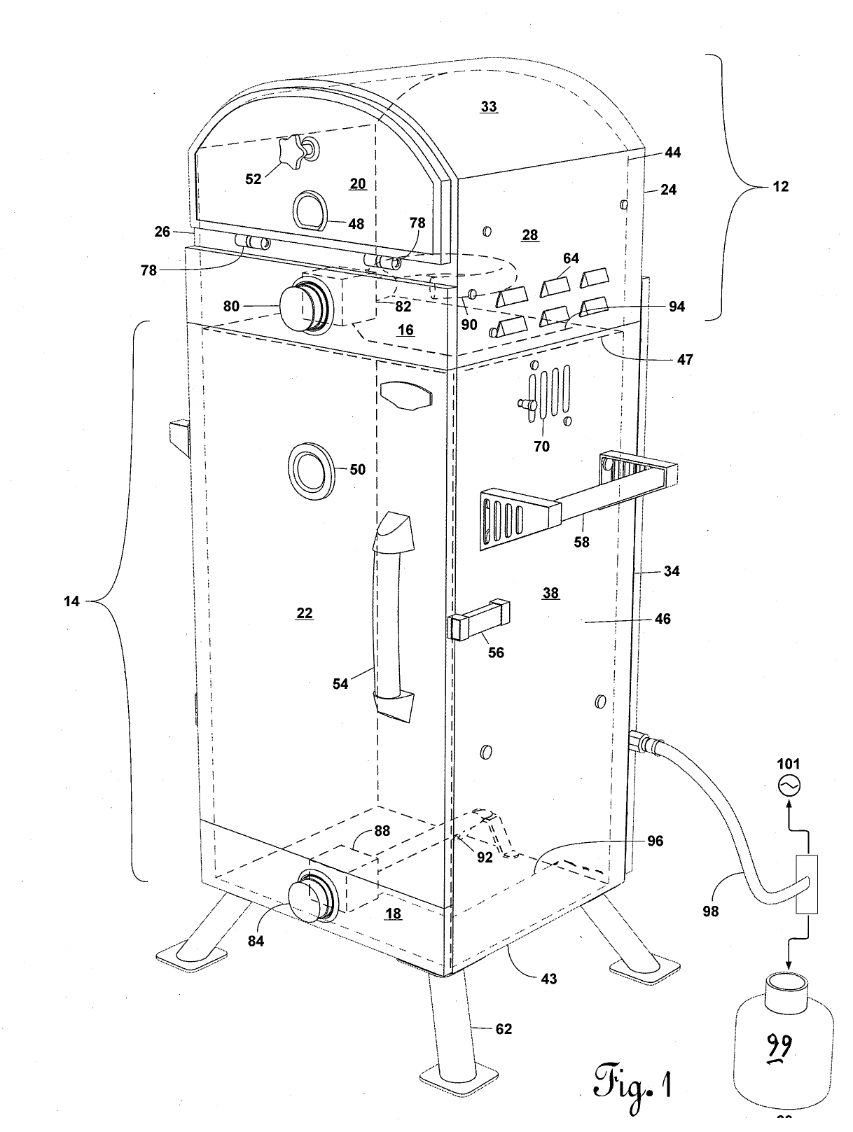

FIGS. 1-4 illustrate Applicant's food cooking apparatus 10. Food cooking apparatus 10 consists of an oven over a smoker, with both the oven and smoker having separate heat sources and sealed from one another, so that substantially no gases pass from the underlying vertical smoker to the overlying oven.

Food cooking apparatus 10 is seen to include an oven cabinet 12 overlying a smoker cabinet 14. An oven control panel 16 is provided for control of energy (typically gas or electric) to the heating element 90 of the oven. Smoker control panel 18 is provided, again for engaging heating elements 92 (may be gas or electric), which heating element is provided to heat smoker cabinet 14. Oven and smoker doors 20/22 are provided with hinges 78, hinged in ways known in the trade, to move between an opened and closed position. The opened position will allow access to smoker interior 46 when the smoker door is open and, when oven door is opened, will provide access to oven cabinet interior 44 of the oven.

Turning back to oven cabinet 12, it is seen to have side walls 24, which may be planar or substantially flat in a preferred embodiment. Side walls 24 may include front wall 26, right side wall 28, left side wall 30, and rear side wall 32. A top wall 33 may be provided, which may be planar or arced or configured in other ways. There is not much to the front wall, as it mostly defines an open space for the doo.

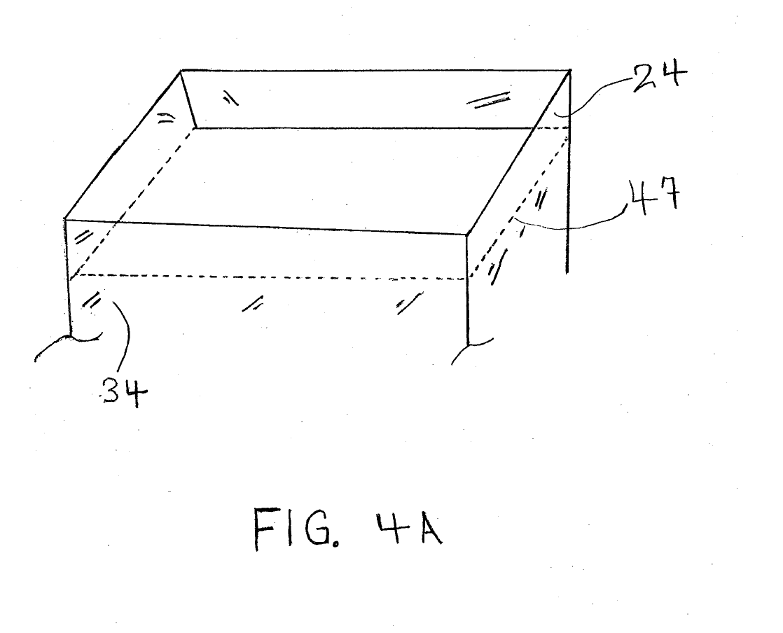

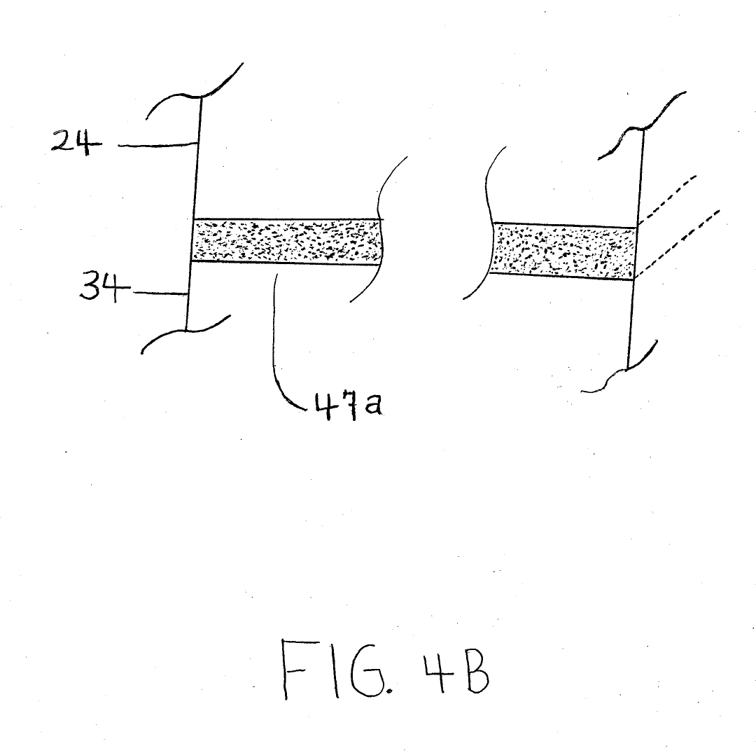

Smoker cabinet 14 may include side walls 34 which, in a preferred embodiment, may be planar and may be contiguous with the side walls 24 of the oven cabinet so they lay in the same plane. Side walls 34 of smoker cabinet 14 may include a front side wall 36 (again, mostly defining a door opening), right side wall 38, left side wall 40, and rear side wall 42. A bottom wall 43 may be provided. A separation wall 47, which may be a single sheet (see FIG. 4A), a double sheet (see FIG. 4B), or any other suitable member, typically joins the side walls of either or both of the cabinets, so as to seal the smoker interior 46 from the oven interior 44, so that gas does not pass between the two.

The side walls of the two cabinets are typically vented through damper assemblies. Oven damper assemblies 64/66/68 may be provided in the right, rear, and left side walls of the oven cabinet 12, or any other suitable locations, to vent the interior of the oven cabinet. Likewise, smoker damper assemblies 70/72/76 may be provided in the side walls or other suitable location of the smoker cabinet 14, so as to provide venting between the interior of the smoker cabinet and the exterior. The damper assemblies may be adjustable as known in the art.

Door hinges 78 are conventional and may be provided for articulating doors 20/22. Doors may include door handles 52/54 which, in one embodiment, are threaded on with fasteners which pass through the inside of the door to threaded mounting bosses or channels on the door handles. In this manner, they may be removed from the inside and leave the door surfaces flush or flat. The substantially flat door surfaces, along with the similar removable cabinet handles 58/60, will provide for ease of packaging, given that with the flat side walls, flat bottom wall, and removal of the handles, packaging in a substantially rectangular package is more easily achieved.

Thermometers 48/50 are typically mounted on doors 20/22 in ways known in the art to measure the temperature of the smoker and oven interior. Legs 62 may be mounted to a typically flat smoker bottom wall 43 by threading fasteners from the inside of the bottom wall through the bottom wall into mounting studs at the upper end of the legs 62. The purpose of the legs is to mount the food cooking apparatus above a support surface, such as a floor or deck.

Turning back to oven and smoker control panels 16/18, they are seen to include control knobs 80/84, which may be rotatably mounted to the exterior of the panel, control knobs typically include a shaft passing through the control panel and into control valves 82/86, which are known in the art. Heating elements 90/92 are provided typically within the interior of the smoker and oven cabinets, and are independently operated to control and provide access of energy to the interior of the smoker/oven. That is to say, heating elements 90/92, which engage internal energy engagement pipes 94/96 through control valves 82/86 are provided. An external energy engagement conduit 98 may be provided. When compressed gas 99 is used as a heat source, a flexible gas line is provided that attaches typically to the rear or any other suitable place on food cooking apparatus 10. It will typically tie into internal energy engagement pipes 94/96 (one to each heating element), which may be metal conduit, such as copper tubing or stainless steel, and which may include a T-junction where the end of energy engagement conduit, which may be flexible pipe meets internal energy engagement pipes 94/96. Note that the gas supply to burner element is independently controlled through separate control valves 82/86.

If electrical energy 101 is used, external conduit 98 may be an electrical cord and internal energy engagement pipes 94/96 may be solid pipe carrying conductors with proper insulation to control valves 82/86. In the case of electrical energy 101, the heating elements 90/92 may be electric as is known in the art. It is also in one embodiment, a mixture of gas and electric—either the top or the bottom being one of gas or electric, and the other of the top or bottom being the other of gas or electric. For either gas or electric, control knobs 80/84 and control valves 82/86 are known in the art, as are heating elements 90/92 for either gas or electric.

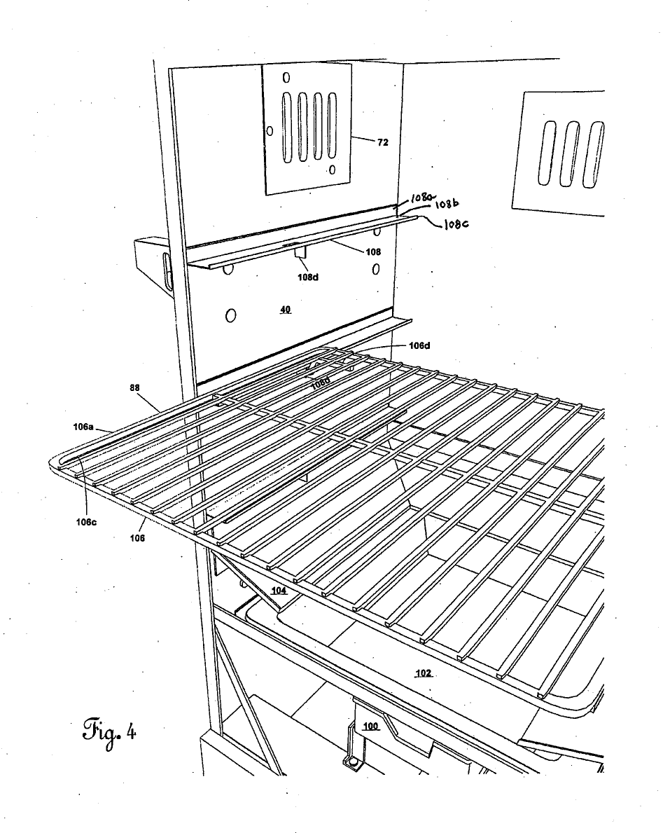

Turning now to FIG. 3, some of the details of the interior of smoker cabinet 14 may be seen. Smoker cabinet 14 may include a woodchip box 100 with walls configured to have an open top and to be able to receive woodchips therein. Support members in the cabinet interior, here extending from the bottom wall up to the woodchip box 100, maintain the woodchip box 100 over heating element 92. A water pan 102 is seen configured with an open top and capable of holding a fluid, such as water, therein. Again, rails, busses, legs or other support members may be provided engaging the interior walls of the smoker cabinet to maintain water pan 102 located typically above heating element 92. Drip rails 104 are seen engaging the side walls of the smoker cabinet interior and canted downward so as to direct fluids, such as fat or grease, into water pan 102.

Above the woodchip box 100 and water pan 102 are seen to be one or more grid assemblies 88. Grid assemblies 88 are seen to include grid members 106 engaging L shaped side rails 108 in a manner that allows the grid members to slide in a horizontal plane outwards when the door is opened.

In one configuration, grid assemblies 88 are configured in ways known in the art and simply slide back and forth in such a manner that they are capable of tilting when pulled out, for example, if there is a heavy dish near the front of the grid member 106 and the grid member is pulled out, the weight of a dish may cause it to pivot. However, in another embodiment, grid assemblies 88 may be non-tilting.

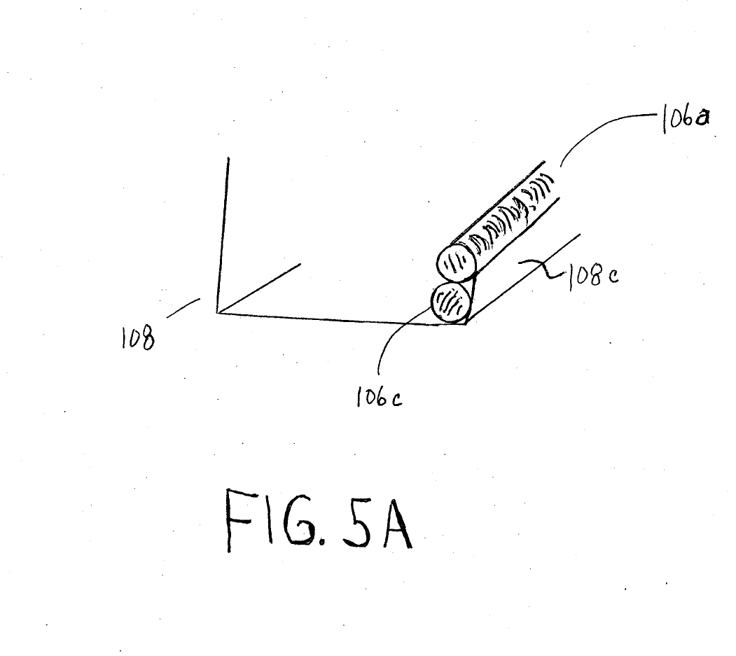

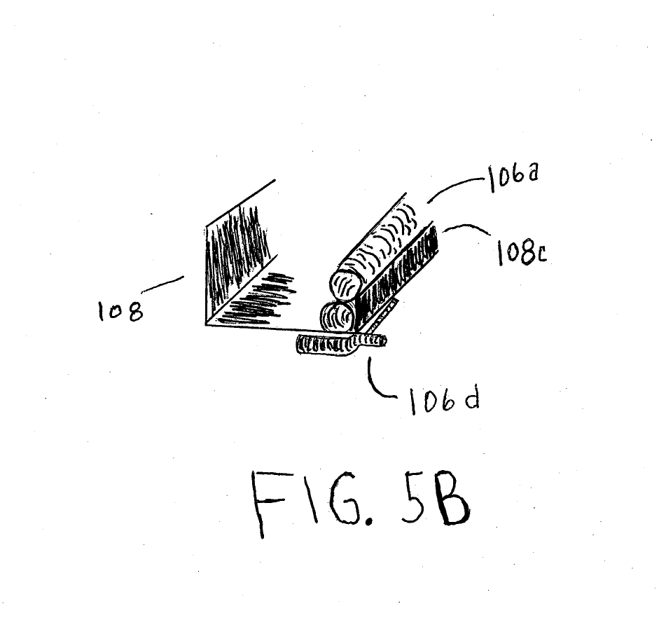

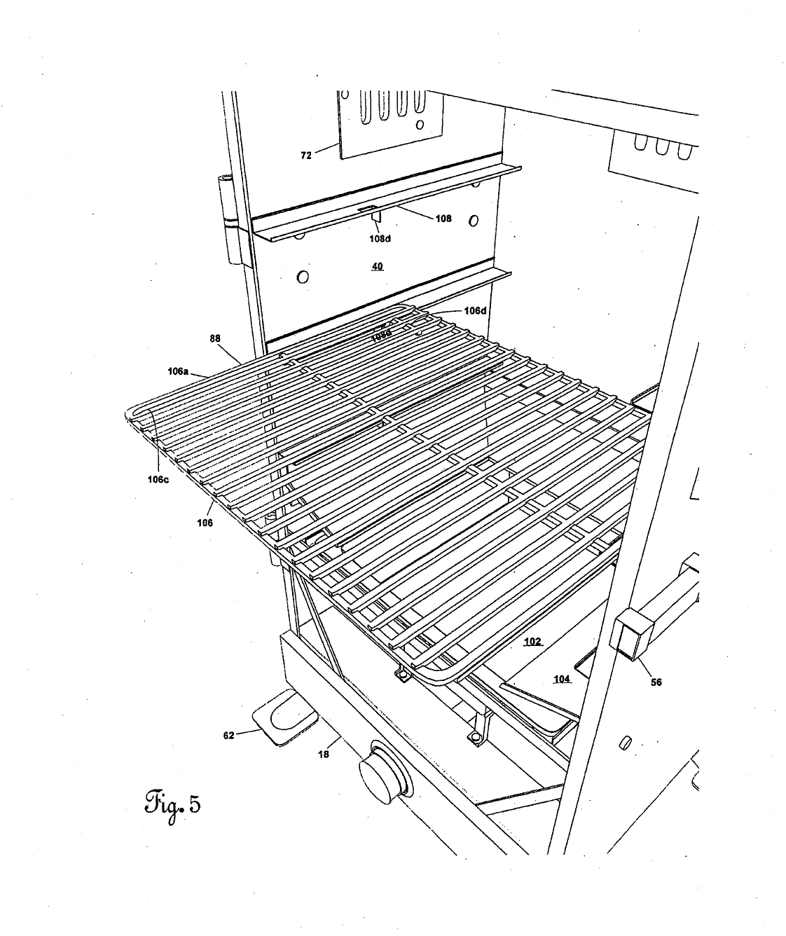

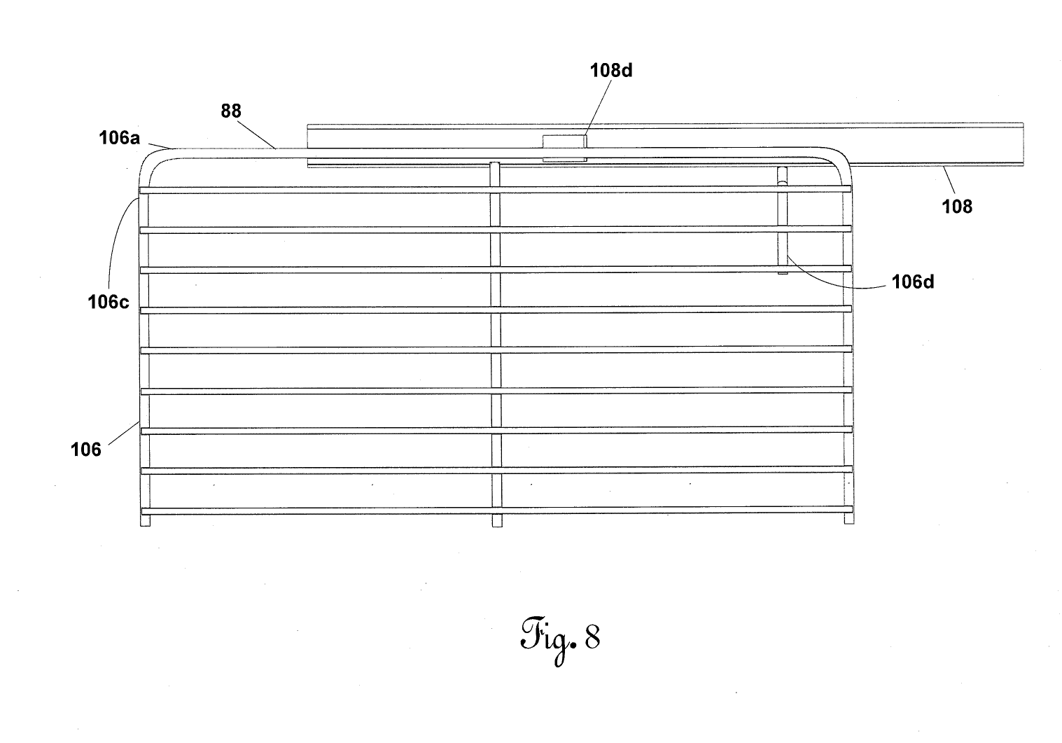

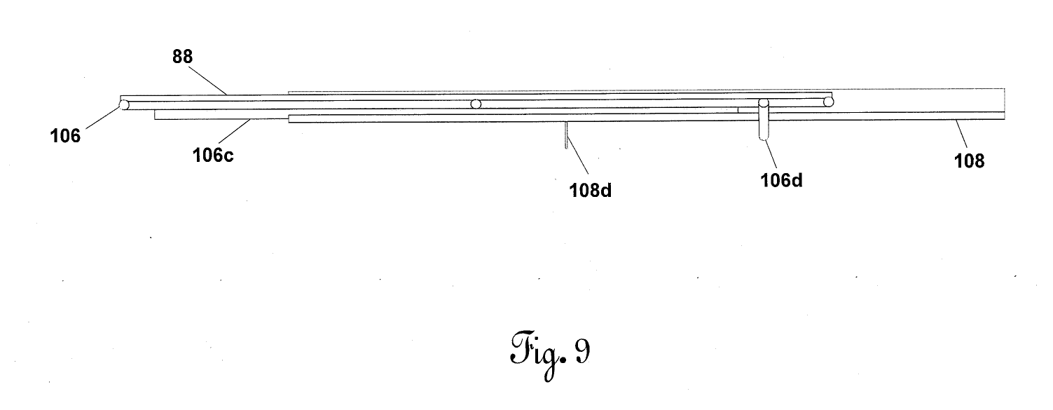

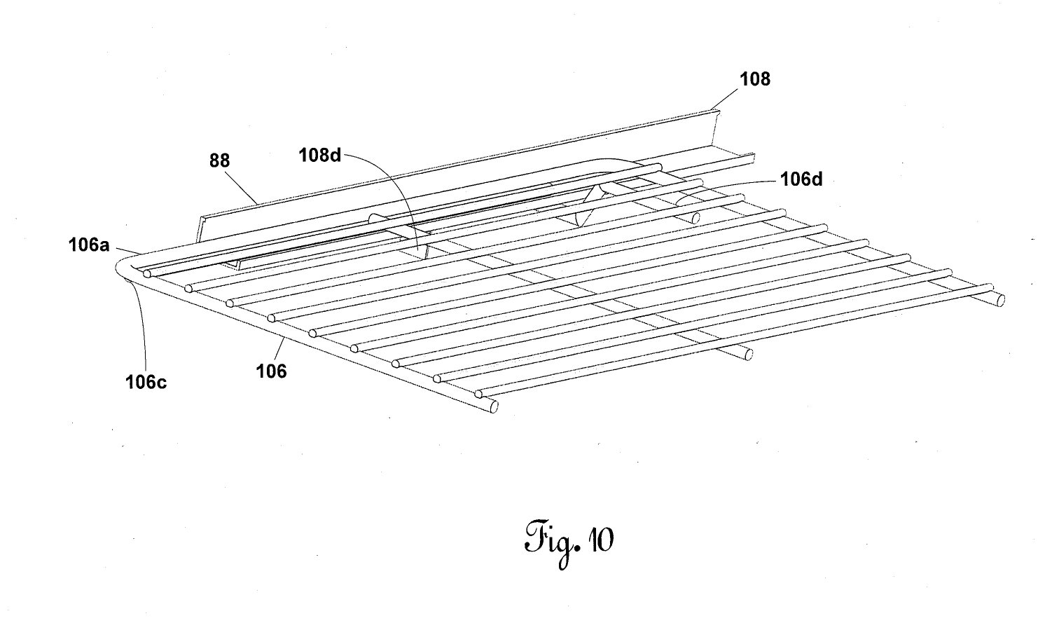

FIGS. 3, 4, 5A, 5B, and 8-10 illustrate a non-tilting grid assembly 88. In this configuration, grid member 106 is seen to include a pair of spaced apart grid side rails 106a. it is noted that in this configuration, L shaped slide rails 108 may include a vertical leg 108a, which typically joins the inner wall of the side walls of the smoker cabinet. Extending outward generally perpendicular from leg 108a is a foot 108b. At the removed end of foot 108b is a substantially vertically upturned lip 108c. A stop member 108d depends downward from the underside of foot 108b as seen in FIG. 4 to engage a configured member 106d located perpendicular to the transverse members of the grid member near the trailing edge as seen in FIGS. 4 and 5B. Configured member 106d is configured to engage the underside of foot 108b in a slideable manner so as to sandwich capture foot 108b between the upper surface of the removed end of configured member 106d and a lower member of lower rail 106c. Lower rail 106c is fastened as by welding or the like to the underside of side rail 106a. Moreover, the inner walls of lower rail 106c snugly engage the inner walls of lip 108c, so when the grid member slides in and out it will not get cocked sideways or jammed (See FIG. 5A). Thus, with non-tilting grid assemblies 88, there is contact between the underside of the side rails and the upper surface of 108b, as well as contact between the upper surface of the removed end of configured member 106d and the underside of foot 108b to prevent tilting of pivoting of a heavy object, such as a pan, is near the front of the grid member when it is pulled out. Moreover, snug contact fit between the inner walls of opposed lips 108c and the outer surfaces of lower rail 106c will prevent tilting.

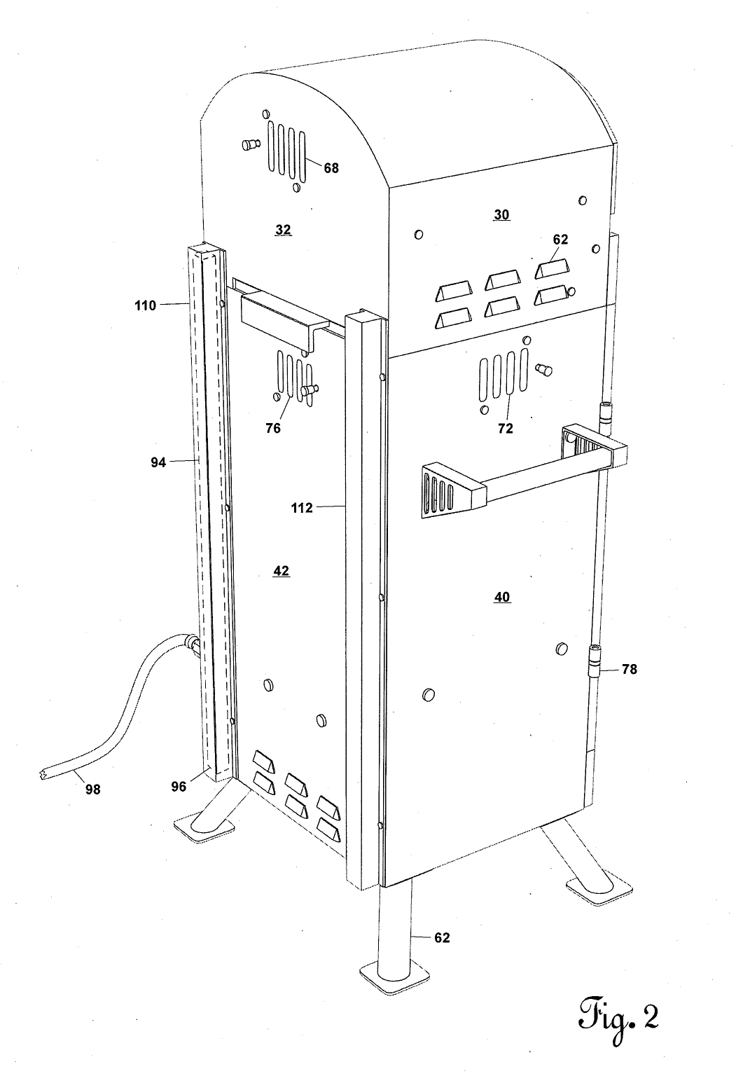

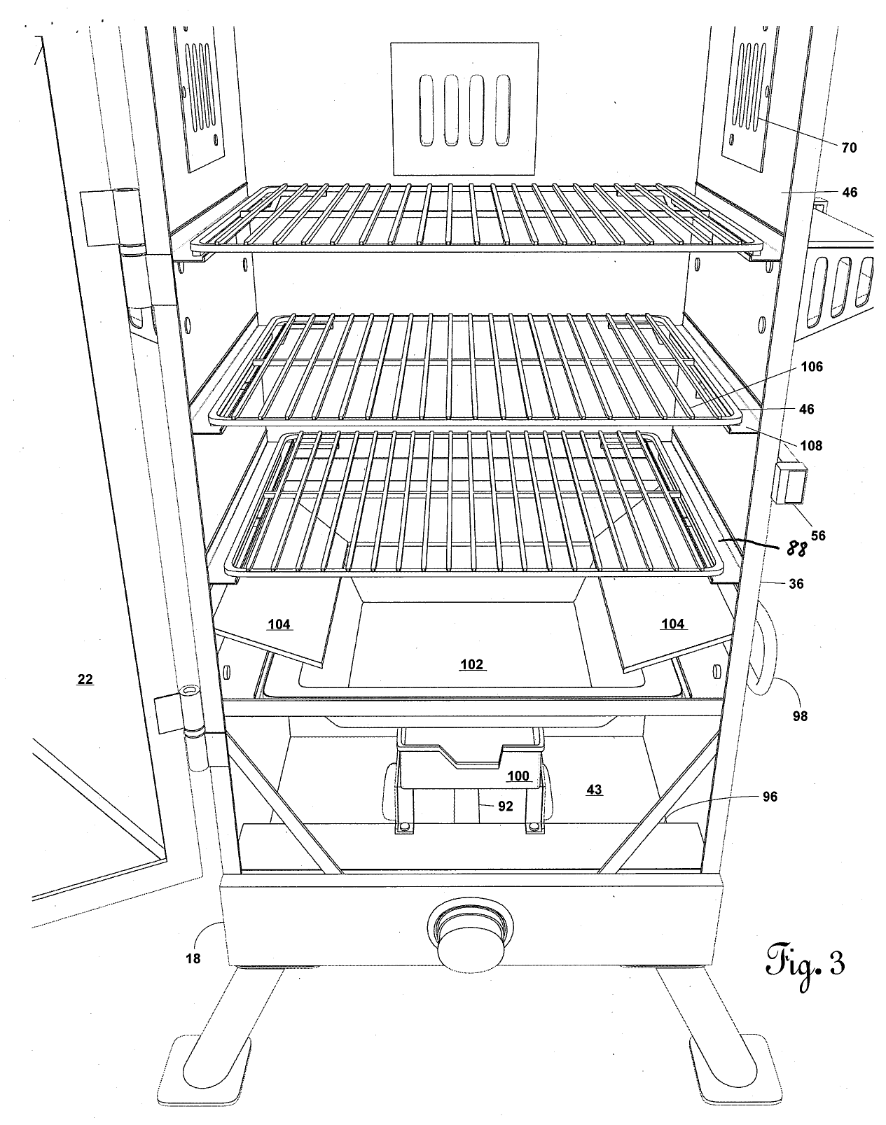

FIGS. 1-7 illustrate further details of Applicant's food cooking apparatus 10. In FIG. 2 it is seen that in a rear view at least partially engaging some of the rear walls are U-shaped channels 110/112 trending vertically on the left and right edges of the rear wall and intended to provide a flat surface for laying the device in a shipping container and also for protection of elements, including energy-engagement pipes 94/96 therein.

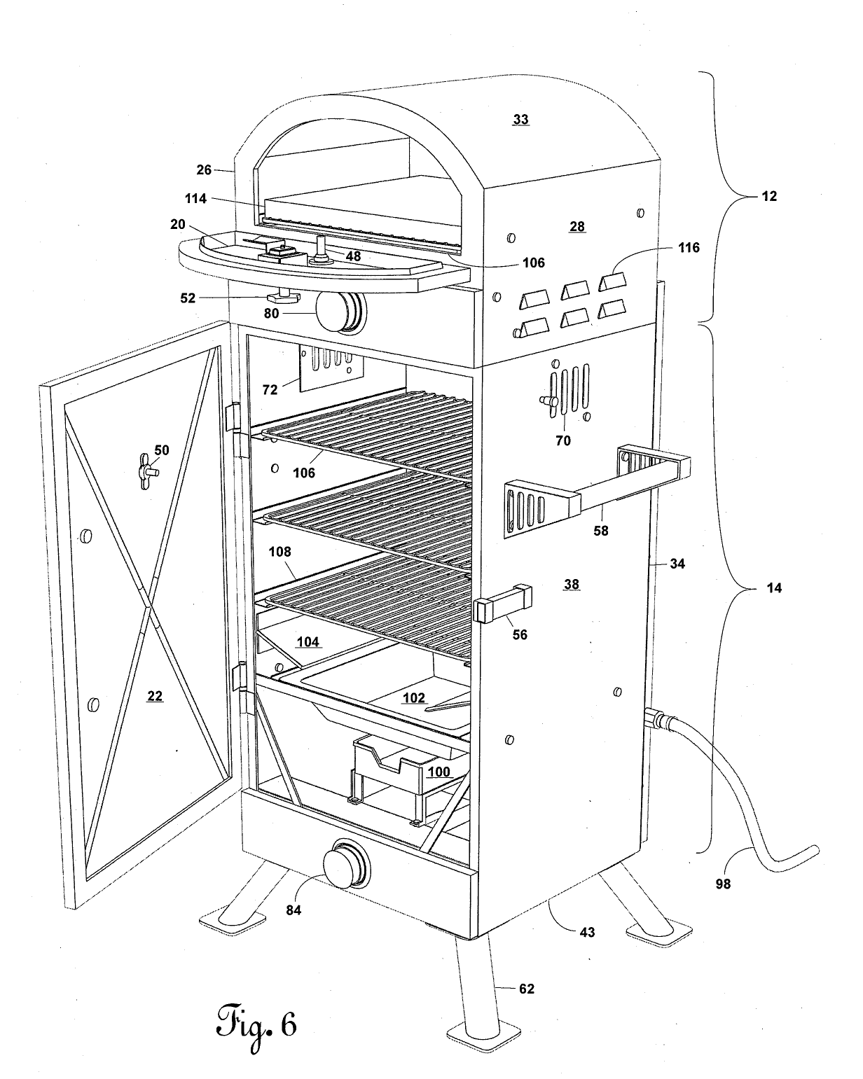

FIG. 6 illustrates a cooking stone 114 in one embodiment rectangular and dimensioned to fit within the door of the upper oven. Cooking stone 114 is adapted to simply lay on a grid member 106. It is also seen that louvers 116 may be seen for use in conjunction with a damper assembly. Louvers may be used or damper assemblies may be used without louvers at any of the locations on the smoker suitable for use.

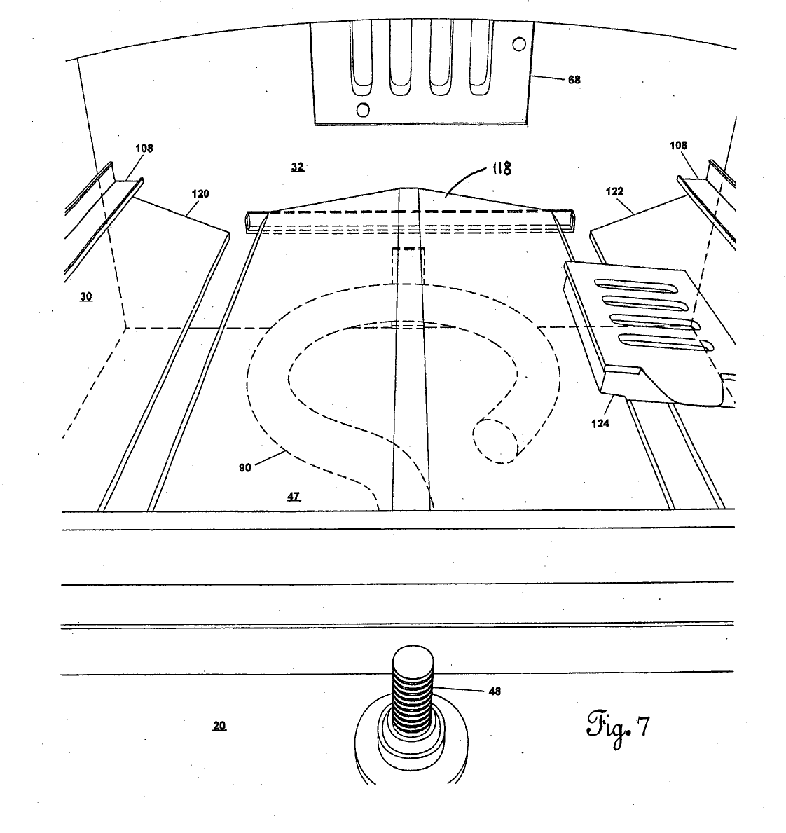

FIG. 7 illustrates the interior of the oven and shows the manner in which a diverting tent or plate 118 which may be shaped like an inverted V may be placed on brackets or other cabinet wall support to receive anything that may drip from food being cooked within the oven to protect the burner from such drippings. Moreover, it is seen that canted side rails 120/122 may be provided to divert drippings. Also, it is seen that a wood chip box 124 may be used for placement within the oven, for example, on the surface of the grid (not shown in FIG. 7 but shown in FIG. 6) or on the surface of the cooking stone 114.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A food cooking apparatus comprising:
a smoker, the smoker having a smoker cabinet having sidewalls, a closed top wall and a bottom wall, the cabinet walls defining a cabinet interior, and a door moveable between an open position and closed position, the open position allowing access to the cabinet interior, the closed position preventing such access;
a smoker control panel engaging the smoker cabinet, the control panel having a control valve engaged therewith;
a smoker heating element comprising either an electrical element or a gas element, the heating element disposed in the cabinet interior above the bottom wall thereof and engaging the control valve;
a wood chip container;
a cabinet engaging support member adapted to maintain the wood chip container above the smoker heating element;
at least one moveable cooking grid;
a cabinet smoker damper assembly engaging the smoker cabinet so as to provide gaseous communication between the interior of the smoker cabinet and an exterior thereof;
an oven, the oven having an oven cabinet, the oven cabinet having side walls and a cabinet floor, a top wall, an oven door moveable between an open and a closed position, the open position allowing access to the cabinet interior, the closed position preventing such access, the oven cabinet in gas sealing relation with the smoker cabinet such that almost all or all of the gas in the interior of the smoker and gas in the interior of the oven do not communicate with one another;
an oven control panel having a control valve engaged therewith;
the oven including an oven heating element, the oven heating element comprising either a gas or an electrical element, the overheating element disposed in the oven cabinet interior, the oven heating element engaging the control valve of the oven control panel;
a rack disposed within the oven cabinet;
an oven damper assembly engaging the oven cabinet so as to provide for the communication of gases between the interior of the cabinet and the exterior thereof; and
an energy source for energizing the heating elements of the smoker and the oven.

2. The food cooking apparatus of claim 1, wherein the cabinet smoke damper assembly is engaged with the side walls of the smoker cabinet.

3. The food cooking apparatus of claim 1, wherein the smoker cabinet has a vertical dimension greater than the horizontal dimension thereof.

4. The food cooking apparatus of claim 1, wherein the energy source is electrical.

5. The food cooking apparatus of claim 1, wherein the energy source is gas.

6. The food cooking apparatus of claim 1, wherein the energy source is a combination of gas portion for providing heat to one of the cabinets and an electrical portion for providing heat to the other of the cabinets.

7. The food cooking apparatus of claim 1, further including legs for engaging the smoker cabinet so as to support the food cooking apparatus above a support surface.

8. The food cooking apparatus of claim 1, further including a pizza stone configured to pass through the oven cabinet door and to fit within the interior of the oven cabinet.

9. The food cooking apparatus of claim 1, further including an oven woodchip box configured to pass through the oven door.

10. The food cooking apparatus of claim 1, wherein the oven cabinet and the smoker cabinet each have thermometers engaged therewith, at least a portion of which are adapted to engage the interior of each cabinet.

11. The food cooking apparatus of claim 1, wherein the length and width of the side walls of the oven cabinet are substantially the same as the length and width of the smoker cabinet.

12. The food cooking apparatus of claim 10, further including a multiplicity of removable handles adapted to engage one or more of the walls of the cabinet.

13. The food cooking apparatus of claim 1, wherein the bottom wall of the smoker is flat, and wherein the side walls of the cabinets are flat.

14. The food cooking apparatus of claim 1, wherein the oven cabinet is disposed over the smoke cabinet.

15. The food cooking apparatus of claim 1, wherein the moveable cooking grid is non-tilting.

16. A food cooking apparatus comprising:
a smoker, the smoker having a smoker cabinet having sidewalls and a bottom wall, the cabinet walls defining a cabinet interior, and a door moveable between an open position and closed position, the open position allowing access to the cabinet interior, the closed position preventing such access;
a smoker control panel engaging the smoker cabinet, the control panel having a control valve engaged therewith;
a smoker heating element comprising either an electrical element or a gas element, the heating element disposed in the cabinet interior above the bottom wall thereof and engaging the control valve;
a wood chip container;
a cabinet engaging support member adapted to maintain the wood chip container above the smoker heating element;
at least one cooking grid adapted to engage the cabinet;
a cabinet smoker damper assembly engaging the smoker cabinet so as to provide gaseous communication between the interior of the smoker cabinet and an exterior thereof;
an oven, the oven having an oven cabinet, the oven cabinet having side walls and a cabinet floor, a top wall, an oven door moveable between an open and a closed position, the open position allowing access to the cabinet interior, the closed position preventing such access, the oven cabinet in gas sealing relation with the smoker cabinet such that gas in the interior of the smoker and gas in the interior of the oven substantially do not communicate with one another;
an oven control panel having a control valve engaged therewith;
the oven including an oven heating element, the oven heating element comprising either a gas or an electrical element, the overheating element disposed in the oven cabinet interior, the oven heating element engaging the control valve of the oven control panel;
a rack disposed within the oven cabinet;
an oven damper assembly engaging the oven cabinet so as to provide for the communication of gases between the interior of the cabinet and the exterior thereof; and
an energy source for energizing the heating elements of the smoker and the oven;
wherein the cabinet smoke damper assembly is engaged with the side walls of the smoker cabinet;
wherein the smoker cabinet has a vertical dimension greater than the horizontal dimension thereof;
wherein the oven cabinet and the smoker cabinet each have thermometers engaged therewith, at least a portion of which are adapted to engage the interior of each cabinet;
wherein the length and width of the side walls of the oven cabinet are substantially the same as the length and width of the smoker cabinet.
further including a multiplicity of removable handles adapted to engage one or more of the walls of the cabinet.
wherein the bottom wall of the smoker is flat, and wherein the side walls of the cabinets are flat.

17. The food cooking apparatus of claim 16, wherein the energy source is electrical.

18. The food cooking apparatus of claim 16, wherein the energy source is gas.

19. The food cooking apparatus of claim 16, wherein the energy source is a combination of a gas portion for providing heat to one of the cabinets and an electrical portion for providing heat to the other of the cabinets.

20. The food cooking apparatus of claim 16, further including a pizza stone configured to pass through the oven cabinet door and to fit within the interior of the oven cabinet.

21. The food cooking apparatus of claim 16, further including an oven woodchip box configured to pass through the oven door.

22. The food cooking apparatus of claim 16, including a rack and side rails configured to engage the rack so the rack may slide with respect to the side rails and such that the side rails engage the walls of the cabinet.

23. The food cooking apparatus of claim 16, wherein the smoker cabinet has a vertical dimension greater than the horizontal dimension thereof and lies below the oven cabinet.

24. The food cooking apparatus of claim 16, wherein the length and width of the side walls of the oven cabinet are substantially the same as the length and width of the smoker cabinet.
